(19) United States
(12) Patent Application Publication
(10) Pub. No.: US 2012/0214085 A1
(43) Pub. Date: Aug. 23, 2012

(54) FUEL CELL OF SOLID OXIDE FUEL CELL

(75) Inventors: Taku OKAMOTO, Nagoya-City (JP); Makoto Ohmori, Nagoya-City (JP)

(73) Assignee: NGK Insulators, Ltd., Nagoya-City (JP)

(21) Appl. No.: 13/423,623

(22) Filed: Mar. 19, 2012

Related U.S. Application Data
(63) Continuation of application No. PCT/JP2010/064297, filed on Aug. 24, 2010.

(30) Foreign Application Priority Data
Sep. 25, 2009 (JP) 2009-219911

(51) Int. Cl. H01M 8/10; H01M 4/86

(52) U.S. Cl. 429/482

(57) ABSTRACT

An SOFC unit cell 100 includes a fuel-side electrode 110, an electrolyte 120 stacked on the fuel-side electrode 110, and an oxygen-side electrode 130 stacked on the electrolyte 120. The fuel-side electrode 110 is formed of NiO and/or Ni and YSZ. The amount by volume of Ni and/or NiO is 35 to 55 vol. %, as reduced to Ni, on the basis of the entirety of the fuel-side electrode, and the amount by volume of YSZ is 45 to 65 vol. % on the basis of the entirety of the fuel-side electrode. The ratio of the mean particle size of YSZ (R2) to the mean particle size of Ni and/or NiO (R1); i.e., R2/R1, is 0.5 or more. Reduction treatment of the fuel-side electrode 110 after firing is carried out by supplying a reducing gas containing a reducing agent (hydrogen) in an amount of 4 to 100 vol. % at a high temperature of 800° C.

### TECHNICAL FIELD

The present invention relates to a unit cell for a solid oxide fuel cell.

### BACKGROUND ART

A unit cell for a solid oxide fuel cell (SOFC) (hereinafter may be referred to as an “SOFC unit cell”) is formed by sequentially stacking a solid electrolyte and an oxygen-side electrode on a surface of a fuel-side electrode. In the SOFC unit cell, when a fuel gas (e.g., hydrogen gas) is supplied to the fuel-side electrode, and an oxygen-containing gas (e.g., air) is supplied to the oxygen-side electrode, a potential difference is generated between the fuel-side electrode and the oxygen-side electrode on the basis of the oxygen ion conductivity of the solid electrolyte.

Hitherto, the present applicant has proposed a mode of such an SOFC unit cell in which “the fuel-side electrode is formed of Ni and/or NiO and a ceramic material exhibiting oxygen ion conductivity (e.g., Y₂O₃-stabilized ZrO₂ (YSZ)) such that the fuel-side electrode has the largest thickness of all the components of the SOFC unit cell, and the fuel-side electrode also serves as a support of the unit cell” (see, for example, Japanese Patent Application Laid-Open (kokai) No. 2009-4353). Thus, the following description will be focused on such an SOFC unit cell in which the fuel-side electrode is formed of Ni and/or NiO and a ceramic material exhibiting oxygen ion conductivity (e.g., YSZ), and the fuel-side electrode also serves as a support.

In general, the fuel-side electrode, the solid electrolyte, and the oxygen-side electrode are formed through firing. Since the fuel-side electrode is required to exhibit electrical conductivity, the fuel-side electrode formed through firing (i.e., fired product) must be subjected to thermal treatment under supply of a reducing gas at high temperature (hereinafter the treatment may be referred to as “reduction treatment”) so that NiO is reduced to Ni.

However, when NiO is converted into Ni through this reduction treatment, a change in size (change in volume) occurs in the fuel-side electrode. This may cause a problem in that cracking occurs in the solid electrolyte formed on a surface of the fuel-side electrode, which also serves as a support, or the solid electrolyte is removed from the fuel-side electrode.

### SUMMARY OF THE INVENTION

An object of the present invention is to provide an SOFC unit cell in which, upon reduction treatment, a change in size is suppressed in a fuel-side electrode which is formed of Ni and/or NiO and a ceramic material exhibiting oxygen ion conductivity and which also serves as a support, and thus problems (e.g., cracking in a solid electrolyte) are less likely to occur.

The SOFC unit cell of the present invention comprises a fuel-side electrode which also serves as a support, and which is formed of Ni and/or NiO, whose amount by volume is 35 to 55 vol. %, as reduced to Ni, on the basis of the entirety of the fuel-side electrode, and a ceramic material exhibiting oxygen ion conductivity, whose amount by volume is 45 to 65 vol. % on the basis of the entirety of the fuel-side electrode; a solid electrolyte; and an oxygen-side electrode, the solid electrolyte and the oxygen-side electrode being sequentially provided on a surface of the fuel-side electrode. In the SOFC unit cell of the present invention, when L1 represents the size of the fuel-side electrode as measured at ambient temperature before thermal treatment of the fuel-side electrode in a reducing atmosphere at 800° C.; L2 represents the size of the fuel-side electrode as measured at ambient temperature after the thermal treatment; and a change in size (ΔL) of the fuel-side electrode is represented by (L2-L1), ΔL/L1 is −0.05 to 0.05%.

As used herein, the term “volume” does not include the volume of a space taken by pores. That is, the expression “the amount by volume of Ni and/or NiO on the basis of the entirety of the fuel-side electrode” refers to the total amount by volume of Ni and/or NiO contained in the fuel-side electrode on the basis of the volume of the entire fuel-side electrode (exclusive of the volume of spaces taken by pores). Meanwhile, the expression “the amount by volume of a ceramic material exhibiting oxygen ion conductivity on the basis of the entirety of the fuel-side electrode” refers to the total amount by volume of the ceramic material contained in the fuel-side electrode on the basis of the volume of the entire fuel-side electrode (exclusive of the volume of spaces taken by pores).

The present inventors have found that, in the case where the amount by volume of Ni and/or NiO is 35 to 55 vol. %, as reduced to Ni, on the basis of the amount of the entire fuel-side electrode, which also serves as a support, and the amount by volume of the ceramic material exhibiting oxygen ion conductivity is 45 to 65 vol. % on the basis of the amount of the entire fuel-side electrode, when the ratio of the particle size of Ni and/or NiO to that of the ceramic material exhibiting oxygen ion conductivity is adjusted, and the reducing agent content of a reducing gas employed for reduction treatment is adjusted, the change in size (ΔL) of the fuel-side electrode, which is determined from the sizes thereof measured before and after reduction treatment, can be controlled to fall within a range of ±0.05%. Also, the present inventors have found that when the change in size (ΔL) of the fuel-side electrode, which is determined from the sizes thereof measured before and after reduction treatment, falls within a range of ±0.05%, problems (e.g., cracking in the solid electrolyte) do not occur.

It has been found that, specifically, in order to adjust the change in size (ΔL) of the fuel-side electrode (which is determined from the sizes thereof measured before and after reduction treatment) to fall within a range of ±0.05%, preferably, R2/R1 (wherein R1 represents the mean particle size of Ni and/or NiO contained in the fuel-side electrode, and R2 represents the mean particle size of the ceramic material exhibiting oxygen ion conductivity contained in the fuel-side electrode) is adjusted to 0.5 or more.

Also, it has been found that, in order to adjust the change in size (ΔL) of the fuel-side electrode (which is determined from the sizes thereof measured before and after reduction treatment) to fall within a range of ±0.05%, preferably, the reducing agent content of a reducing gas employed for reduction treatment is adjusted to 4 to 100 vol. %.

Examples of the ceramic material (oxide) exhibiting oxygen ion conductivity include Y₂O₃-stabilized ZrO₂ (yttria-stabilized zirconia, YSZ), Sc₂O₃-stabilized ZrO₂ (scandia-stabilized zirconia), and (Gd,Ce)O₂ (gadolinium-doped ceria). (Sm,Ce)O₂ (samarium-doped ceria), lanthanum gallate, etc. may also be employed.

### BRIEF DESCRIPTION OF THE DRAWINGS

FIG. 1 is a schematic representation of the configuration of an SOFC unit cell according to an embodiment of the present invention.

### MODE FOR CARRYING OUT THE INVENTION

### Configuration

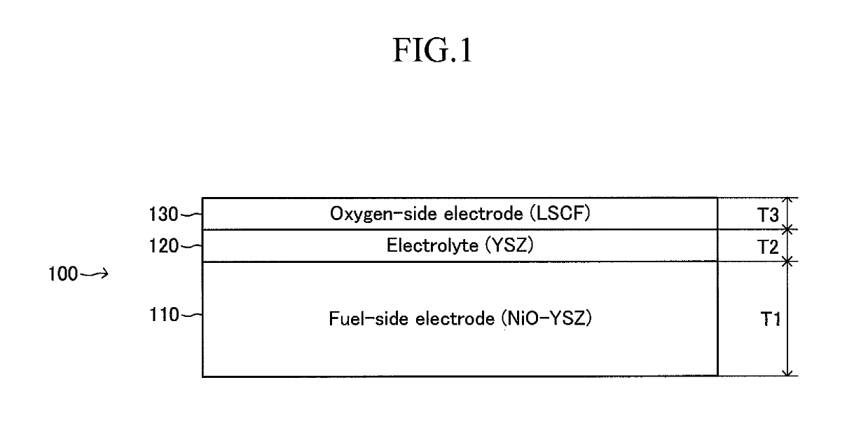

FIG. 1 shows the configuration of an SOFC unit cell 100 according to an embodiment of the present invention. The SOFC unit cell 100 is a layered product including a fuel-side electrode 110, an electrolyte 120 stacked on the fuel-side electrode 110, and an oxygen-side electrode 130 stacked on the electrolyte 120. As viewed from above, the unit cell 100 is in the form of, for example, square (each side: 1 to 10 cm), rectangle (longer side: 5 to 30 cm, shorter side: 3 to 15 cm), or circle (diameter: 10 cm).

The fuel-side electrode 110 (anode) is a porous, thin plate-like fired product formed of nickel oxide (NiO) and/or nickel (Ni) and yttria-stabilized zirconia (YSZ). The amount by volume of Ni and/or NiO is 35 to 55 vol. %, as reduced to Ni, on the basis of the entirety of the fuel-side electrode, and the amount by volume of YSZ is 45 to 65 vol. % on the basis of the entirety of the fuel-side electrode. When the mean particle size of Ni and/or NiO is represented by R1, and the mean particle size of YSZ is represented by R2, the ratio R2/R1 is 0.5 or more.

The fuel-side electrode 110 has a thickness T1 of 0.3 to 3 mm. The fuel-side electrode 110 has the largest thickness of all the constitutive members of the unit cell 100, and the fuel-side electrode 110 also serves as a support (support substrate; i.e., a member having the highest rigidity) of the unit cell 100.

The electrolyte 120 is a dense, thin plate-like fired product formed of YSZ. The electrolyte 120 has a thickness T2 of 3 to 30 μm.

The oxygen-side electrode 130 (cathode) is a porous, thin plate-like fired product formed of lanthanum strontium cobalt ferrite (LSCF, La_{0.6}Sr_{0.4}Co_{0.2}Fe_{0.8}O₃). The oxygen-side electrode 130 has a thickness T3 of 5 to 50 p.m.

A reaction preventing layer may be provided between the electrolyte 120 and the oxygen-side electrode 130 for preventing an increase in electrical resistance between the electrolyte 120 and the oxygen-side electrode 130 due to reaction between YSZ contained in the electrolyte 120 and strontium contained in the oxygen-side electrode 130 in the unit cell 100 during production of the unit cell or during operation of the SOFC. The reaction preventing layer is preferably a dense, thin plate-like fired product formed of ceria. Specific examples of the ceria include GDC (gadolinium-doped ceria) and SDC (samarium-doped ceria).

In the SOFC unit cell 100, when a fuel gas (e.g., hydrogen gas) is supplied to the fuel-side electrode 110, and an oxygen-containing gas (e.g., air) is supplied to the oxygen-side electrode 130, chemical reactions shown in the following formulas (1) and (2) occur. Thus, a potential difference is generated between the fuel-side electrode 110 and the oxygen-side electrode 130. This potential difference is based on the oxygen ion conductivity of the electrolyte 120.

(½)·O₂+2^{e-}→O²⁺ (at oxygen-side electrode 130) (1)

H₂+O²⁻→H₂O+2^{e-} (at fuel-side electrode 110) (2)

In the SOFC unit cell 100, generally, a conductive connection member (hereinafter may be referred to as an “interconnector”) for power collection is bonded and fixed to each of the fuel-side electrode 110 and the oxygen-side electrode 130 by means of a bonding agent. Electric power based on the aforementioned potential difference is externally extracted through each interconnector.

### (Production Method)

Next will be described a method for producing the SOFC unit cell 100 shown in FIG. 1.

The fuel-side electrode 110 and the electrolyte 120 were produced as follows. Specifically, NiO powder was mixed with YSZ powder, and the resultant mixture was mixed with polyvinyl alcohol (PVA) serving as a binder, to thereby prepare a slurry. The slurry was dried with a spray dryer, followed by granulation, to thereby produce powder for the fuel-side electrode. The powder was subjected to die pressing molding, to thereby form a molded product for the fuel-side electrode. Subsequently, water and a binder were added to and mixed with YSZ powder in a ball mill for 24 hours, to thereby prepare a slurry. The slurry was applied to the molded product for the fuel-side electrode, followed by molding. Thus, a molded product for the electrolyte was formed and stacked on the molded product for the fuel-side electrode. The thus-stacked product was co-sintered by means of an electric furnace in air (i.e., an oxygen-containing atmosphere) at 1,400° C. for two hours, to thereby form a layered product of the fuel-side electrode 110 and the electrolyte 120. Formation of a film to become the electrolyte 120 on the fuel-side electrode 110 may be carried out through tape lamination, printing, or a similar technique.

The oxygen-side electrode 130 was formed on the electrolyte 120 as follows. Specifically, water and a binder were added to and mixed with LSCF powder in a ball mill for 24 hours, to thereby prepare a slurry. The slurry was applied to the electrolyte 120 and then dried, followed by firing by means of an electric furnace in air (i.e., an oxygen-containing atmosphere) at 1,000° C. for one hour. Thus, the oxygen-side electrode 130 was formed on the electrolyte 120.

Thus, stacking of the members forming the unit cell 100 is completed. The fuel-side electrode 110 is required to exhibit electrical conductivity. Therefore, the fuel-side electrode 110 formed through firing (i.e., fired product) was subjected to thermal treatment under supply of a reducing gas at a high temperature of 800° C. (hereinafter the treatment may be referred to as “reduction treatment”). The amount of a reducing agent (specifically, hydrogen) contained in the reducing gas was adjusted to 4 to 100 vol. %. Through this reduction treatment, NiO is reduced to Ni. Thus, description has been made regarding the method for producing the SOFC unit cell 100 shown in FIG. 1.

### (Features, Operations, and Effects of Fuel-Side Electrode)

As described above, in the fuel-side electrode 110 (also serving as a support) of the unit cell 100 according to the aforementioned embodiment, the amount by volume of Ni and/or NiO is 35 to 55 vol. %, as reduced to Ni, on the basis of the entirety of the fuel-side electrode, and the amount by volume of YSZ is 45 to 65 vol. % on the basis of the entirety of the fuel-side electrode. Hereinafter, the size of the fuel-side electrode 110 (fired product) as measured at ambient temperature before the reduction treatment is represented by L1; the size of the fuel-side electrode 110 as measured at ambient temperature after the reduction treatment is represented by L2; and a change in size (ΔL) of the fuel-side electrode 110 is represented by (L2−L1). As used herein, the term “size” refers to, for example, the thickness of the fuel-side electrode 110, or the representative length of the fuel-side electrode 110 in plan view (as viewed from above) (i.e., the diameter when the electrode 110 is in circular form, or the length of each side when the electrode 110 is in square form).

The present inventors have found that, in the case where the amount by volume of each component of the fuel-side electrode 110 falls within the aforementioned range, when the ratio of the particle size of YSZ to that of Ni and/or MO (i.e., R2/R1) is adjusted, and the reducing agent content of the reducing gas employed for reduction treatment is adjusted, the change in size (ΔL) of the fuel-side electrode 110, which is determined from the sizes thereof measured before and after reduction treatment, can be controlled to fall within a range of ±0.05%. Also, the present inventors have found that when the change in size (ΔL) of the fuel-side electrode 110, which is determined from the sizes thereof measured before and after reduction treatment, falls within a range of ±0.05%, problems (e.g., cracking in the electrolyte 120) do not occur. Next will be described a test whose results led to these findings.

### (Test)

In this test, there were prepared a plurality of test samples corresponding to the SOFC unit cell according to the aforementioned embodiment; i.e., test samples (fired products) on the basis of different combinations of “the amounts by volume of Ni and/or NiO and YSZ in the fuel-side electrode 110,” “the ratio of the particle size of YSZ to that of Ni and/or NiO (the ratio R2/R1),” and “the reducing agent (hydrogen) content of a reducing gas employed for reduction treatment.” Specifically, as shown in Table 1, 40 combinations were provided. One test sample was prepared for each combination.

TABLE 1

| | | | Mean | | Mean | | Reducing | Change in size | |
|---|---|---|---|---|---|---|---|---|---|
| | Amount by | Amount by | particle size | Amount by | particle size | | gas | before and after | Occurrence |
| Combination | volume of | volume of | of NiO, Ni | volume of | of YSZ | R2/R1 | amount | reduction | of |
| No. | NiO powder | Ni powder | R1 (μm) | YSZ | R2 (μm) | ratio | (%) | ΔL/L1 (%) | cracking |
| 1 | 58 | 45 | 1.1 | 55 | 3.9 | 3.5 | 100 | −0.02 | x |
| 2 | 58 | 45 | 1.1 | 55 | 3.9 | 3.5 | 70 | −0.01 | x |
| 3 | 58 | 45 | 1.1 | 55 | 3.9 | 3.5 | 50 | 0 | x |
| 4 | 58 | 45 | 1.1 | 55 | 3.9 | 3.5 | 20 | 0 | x |
| 5 | 58 | 45 | 1.1 | 55 | 3.9 | 3.5 | 4 | 0.01 | x |
| 6 | 58 | 45 | 0.8 | 55 | 0.4 | 0.5 | 100 | 0.01 | x |
| 7 | 58 | 45 | 0.8 | 55 | 0.4 | 0.5 | 70 | 0 | x |
| 8 | 58 | 45 | 0.8 | 55 | 0.4 | 0.5 | 50 | 0 | x |
| 9 | 58 | 45 | 0.8 | 55 | 0.4 | 0.5 | 20 | −0.02 | x |
| 10 | 58 | 45 | 0.8 | 55 | 0.4 | 0.5 | 4 | −0.04 | x |
| 11 | 53 | 40 | 0.8 | 60 | 0.4 | 0.5 | 100 | 0.04 | x |
| 12 | 53 | 40 | 0.8 | 60 | 0.4 | 0.5 | 70 | 0.02 | x |
| 13 | 53 | 40 | 0.8 | 60 | 0.4 | 0.5 | 50 | 0 | x |
| 14 | 53 | 40 | 0.8 | 60 | 0.4 | 0.5 | 20 | 0 | x |
| 15 | 53 | 40 | 0.8 | 60 | 0.4 | 0.5 | 4 | −0.01 | x |
| 16 | 51 | 37.5 | 0.8 | 62.5 | 0.4 | 0.5 | 100 | 0.05 | x |
| 17 | 51 | 37.5 | 0.8 | 62.5 | 0.4 | 0.5 | 70 | 0.03 | x |
| 18 | 51 | 37.5 | 0.8 | 62.5 | 0.4 | 0.5 | 50 | 0.02 | x |
| 19 | 51 | 37.5 | 0.8 | 62.5 | 0.4 | 0.5 | 20 | 0.02 | x |
| 20 | 51 | 37.5 | 0.8 | 62.5 | 0.4 | 0.5 | 4 | 0.02 | x |
| 21 | 48 | 35 | 0.8 | 65 | 0.4 | 0.5 | 100 | 0.06 | ∘ |
| 22 | 48 | 35 | 0.8 | 65 | 0.4 | 0.5 | 70 | 0.05 | x |
| 23 | 48 | 35 | 0.8 | 65 | 0.4 | 0.5 | 50 | 0.04 | x |
| 24 | 48 | 35 | 0.8 | 65 | 0.4 | 0.5 | 20 | 0.03 | x |
| 25 | 48 | 35 | 0.8 | 65 | 0.4 | 0.5 | 4 | 0.03 | x |
| 26 | 68 | 55 | 1.1 | 45 | 3.9 | 3.5 | 100 | −0.09 | ∘ |
| 27 | 68 | 55 | 1.1 | 45 | 3.9 | 3.5 | 70 | −0.05 | x |
| 28 | 68 | 55 | 1.1 | 45 | 3.9 | 3.5 | 50 | −0.05 | x |
| 29 | 68 | 55 | 1.1 | 45 | 3.9 | 3.5 | 20 | −0.05 | x |
| 30 | 68 | 55 | 1.1 | 45 | 3.9 | 3.5 | 4 | −0.05 | x |
| 31 | 53 | 40 | 1.1 | 60 | 3.9 | 3.5 | 100 | −0.01 | x |
| 32 | 53 | 40 | 1.1 | 60 | 3.9 | 3.5 | 70 | 0 | x |
| 33 | 53 | 40 | 1.1 | 60 | 3.9 | 3.5 | 50 | 0 | x |
| 34 | 53 | 40 | 1.1 | 60 | 3.9 | 3.5 | 20 | 0 | x |
| 35 | 53 | 40 | 1.1 | 60 | 3.9 | 3.5 | 4 | 0.01 | x |
| 36 | 58 | 45 | 1.8 | 55 | 3.9 | 2.2 | 100 | −0.07 | ∘ |
| 37 | 58 | 45 | 1.8 | 55 | 3.9 | 2.2 | 70 | −0.05 | x |
| 38 | 58 | 45 | 1.8 | 55 | 3.9 | 2.2 | 50 | −0.02 | x |
| 39 | 58 | 45 | 1.8 | 55 | 3.9 | 2.2 | 20 | 0.01 | x |
| 40 | 58 | 45 | 1.8 | 55 | 3.9 | 2.2 | 4 | 0.05 | x |

In each of these test samples, the thickness T1 of the fuel-side electrode 110 (NiO-YSZ) was adjusted to 500 μm; the thickness T2 of the electrolyte 120 (3YSZ) was adjusted to 5 μm; and the thickness T3 of the oxygen-side electrode 130 (LSCF) was adjusted to 30 μm. Each test sample was prepared to have a circular form (diameter: 10 cm) as viewed from above.

As shown in Table 1, the amounts by volume of Ni and/or NiO and YSZ and the mean particle sizes thereof were measured after firing and before reduction treatment. The amounts by volume were calculated through a well-known technique employing fluorescent X-ray. The “amount by volume of Ni and/or NiO” refers to the total amount by volume of Ni and/or NiO contained in the fuel-side electrode 110 on the basis of the volume of the entire fuel-side electrode 110 (exclusive of the volume of spaces taken by pores). The “amount by volume of YSZ” refers to the total amount by volume of YSZ contained in the fuel-side electrode 110 on the basis of the volume of the entire fuel-side electrode 110 (exclusive of the volume of spaces taken by pores).

Hydrogen was employed as a reducing agent contained in the reducing gas. The reducing gas having a reducing agent concentration of 100 vol. % was prepared from hydrogen only, and the reducing gas having a reducing agent concentration of less than 100 vol. % was prepared from hydrogen and argon.

Before reduction treatment, the size of a specific portion of the fuel-side electrode of each of the prepared test samples (fired products) was measured at room temperature (ambient temperature) (hereinafter, the thus-measured size will be referred to as “L1”). Subsequently, while the test sample was heated at 800° C., a reducing gas was supplied to the fuel-side electrode, to thereby carry out reduction treatment. Thereafter, the test sample (reduced product) was cooled to room temperature (ambient temperature), and the size of the specific portion of the fuel-side electrode was again measured (hereinafter, the thus-measured size will be referred to as “L2”). Table 1 shows data of ΔL/L1, which was calculated by diving, by L1, a change in size ΔL (=L2−L1) based on the sizes measured before and after the reduction treatment. It is confirmed that the fired product is converted into the reduced product through the reduction treatment by comparing the weight of the test sample as measured before and after the reduction treatment with the weight of the test sample calculated from the amounts by volume of the components thereof.

Each of the above-prepared test samples was subjected to a thermal cycle test; i.e., 50 thermal treatment cycles, each cycle consisting of a process in which the test sample is heated from room temperature to 800° C.; the test sample is subjected to the aforementioned reduction treatment; and then the test sample is cooled to room temperature while the reducing atmosphere is maintained (i.e., cooling under such a condition that reoxidation is prevented). After completion of the thermal cycle test, the surface of the electrolyte 120 was observed under a binocular microscope for determining the presence or absence of cracking. The results are shown in Table 1.

As is clear from Table 1, when the amount by volume of Ni and/or NiO is 35 to 55 vol. % on the basis of the entirety of the fuel-side electrode 110, and the amount by volume of YSZ is 45 to 65 vol. % on the basis of the entirety of the fuel-side electrode 110, regardless of the amount by volume of Ni and/or NiO, the change in size (ΔL) of the fuel-side electrode 110—which is determined from the sizes thereof measured before and after the reduction treatment can be controlled to fall within a range of ±0.05% by adjusting the ratio of the mean particle size (R2) of YSZ to the mean particle size (R1) of Ni and/or NiO (i.e., R2/R1), and adjusting the reducing agent content of the reducing gas employed for the reduction treatment.

In the test piece (combination: No. 21) in which the change in size (ΔL/L1) based on the sizes measured before and after the reduction treatment exceeded 0.05%, cracking occurred in the electrolyte 120 after the thermal cycle test. Similar to this case, in the test piece (combination: No. 26 or 36) in which the change in size (ΔL/L1) based on the sizes measured before and after the reduction treatment was less than −0.05%, cracking occurred in the electrolyte 120 after the thermal cycle test.

The above-described data show that when the amount by volume of Ni and/or NiO is 35 to 55 vol. % on the basis of the entirety of the fuel-side electrode 110, and the amount by volume of YSZ is 45 to 65 vol. % on the basis of the entirety of the fuel-side electrode 110, the change in size (ΔL) of the fuel-side electrode 110 based on the sizes measured before and after the reduction treatment can be controlled to fall within a range of ±0.05%, and therefore the resultant SOCF unit cell exhibits high reliability without causing any problem (e.g., occurrence of cracking in the surface of the electrolyte 120).

The description has been made by taking, as an example, the case where YSZ is employed as the ceramic material exhibiting oxygen ion conductivity and contained in the fuel-side electrode 110. Next will be described the case where scandia-stabilized zirconia (ScSZ) is employed as the ceramic material exhibiting oxygen ion conductivity and contained in the fuel-side electrode 110.

The same test as described above was carried out in the case where scandia-stabilized zirconia was employed. Also in this case, the particle size ratio R2/R1 was adjusted to be 0.5 or more, and the reducing agent content of the reducing gas employed for reduction treatment is adjusted to fall within a range of 4 to 100 vol. %. The results are shown in Table 2. The “amount by volume of ScSZ” refers to the total amount by volume of ScSZ contained in the fuel-side electrode 110 on the basis of the volume of the entire fuel-side electrode 110 (exclusive of the volume of spaces taken by pores).

TABLE 2

| | | | Mean | | Mean | | Reducing | Change in size | |
|---|---|---|---|---|---|---|---|---|---|
| | Amount by | Amount by | particle size | Amount by | particle size | | gas | before and after | Occurrence |
| Combination | volume of | volume of | of NiO, Ni | volume of | of ScSZ | R2/R1 | amount | reduction | of |
| No. | NiO powder | Ni powder | R1 (μm) | ScSZ | R2 (μm) | ratio | (%) | ΔL/L1 (%) | cracking |
| 1 | 58 | 45 | 1.1 | 55 | 3.9 | 3.5 | 100 | −0.02 | x |
| 2 | 58 | 45 | 1.1 | 55 | 3.9 | 3.5 | 70 | −0.01 | x |
| 3 | 58 | 45 | 1.1 | 55 | 3.9 | 3.5 | 50 | −0.01 | x |
| 4 | 58 | 45 | 1.1 | 55 | 3.9 | 3.5 | 20 | 0 | x |
| 5 | 58 | 45 | 1.1 | 55 | 3.9 | 3.5 | 4 | 0.02 | x |
| 6 | 58 | 45 | 0.8 | 55 | 0.4 | 0.5 | 100 | 0.02 | x |
| 7 | 58 | 45 | 0.8 | 55 | 0.4 | 0.5 | 70 | 0 | x |
| 8 | 58 | 45 | 0.8 | 55 | 0.4 | 0.5 | 50 | −0.01 | x |
| 9 | 58 | 45 | 0.8 | 55 | 0.4 | 0.5 | 20 | −0.03 | x |
| 10 | 58 | 45 | 0.8 | 55 | 0.4 | 0.5 | 4 | −0.05 | x |
| 11 | 53 | 40 | 0.8 | 60 | 0.4 | 0.5 | 100 | 0.04 | x |
| 12 | 53 | 40 | 0.8 | 60 | 0.4 | 0.5 | 70 | 0.01 | x |
| 13 | 53 | 40 | 0.8 | 60 | 0.4 | 0.5 | 50 | 0.01 | x |
| 14 | 53 | 40 | 0.8 | 60 | 0.4 | 0.5 | 20 | −0.01 | x |
| 15 | 53 | 40 | 0.8 | 60 | 0.4 | 0.5 | 4 | −0.01 | x |
| 16 | 51 | 37.5 | 0.8 | 62.5 | 0.4 | 0.5 | 100 | 0.05 | x |
| 17 | 51 | 37.5 | 0.8 | 62.5 | 0.4 | 0.5 | 70 | 0.05 | x |
| 18 | 51 | 37.5 | 0.8 | 62.5 | 0.4 | 0.5 | 50 | 0.03 | x |
| 19 | 51 | 37.5 | 0.8 | 62.5 | 0.4 | 0.5 | 20 | 0.02 | x |
| 20 | 51 | 37.5 | 0.8 | 62.5 | 0.4 | 0.5 | 4 | 0.03 | x |
| 21 | 48 | 35 | 0.8 | 65 | 0.4 | 0.5 | 100 | 0.06 | ∘ |
| 22 | 48 | 35 | 0.8 | 65 | 0.4 | 0.5 | 70 | 0.05 | x |
| 23 | 48 | 35 | 0.8 | 65 | 0.4 | 0.5 | 50 | 0.05 | x |
| 24 | 48 | 35 | 0.8 | 65 | 0.4 | 0.5 | 20 | 0.04 | x |
| 25 | 48 | 35 | 0.8 | 65 | 0.4 | 0.5 | 4 | 0.04 | x |
| 26 | 68 | 55 | 1.1 | 45 | 3.9 | 3.5 | 100 | −0.08 | ∘ |
| 27 | 68 | 55 | 1.1 | 45 | 3.9 | 3.5 | 70 | −0.06 | ∘ |
| 28 | 68 | 55 | 1.1 | 45 | 3.9 | 3.5 | 50 | −0.05 | x |
| 29 | 68 | 55 | 1.1 | 45 | 3.9 | 3.5 | 20 | −0.05 | x |
| 30 | 68 | 55 | 1.1 | 45 | 3.9 | 3.5 | 4 | −0.05 | x |
| 31 | 53 | 40 | 1.1 | 60 | 3.9 | 3.5 | 100 | −0.02 | x |
| 32 | 53 | 40 | 1.1 | 60 | 3.9 | 3.5 | 70 | −0.02 | x |
| 33 | 53 | 40 | 1.1 | 60 | 3.9 | 3.5 | 50 | −0.01 | x |
| 34 | 53 | 40 | 1.1 | 60 | 3.9 | 3.5 | 20 | 0 | x |
| 35 | 53 | 40 | 1.1 | 60 | 3.9 | 3.5 | 4 | 0.02 | x |
| 36 | 58 | 45 | 1.8 | 55 | 3.9 | 2.2 | 100 | −0.07 | ∘ |
| 37 | 58 | 45 | 1.8 | 55 | 3.9 | 2.2 | 70 | −0.06 | ∘ |
| 38 | 58 | 45 | 1.8 | 55 | 3.9 | 2.2 | 50 | −0.03 | x |
| 39 | 58 | 45 | 1.8 | 55 | 3.9 | 2.2 | 20 | 0 | x |
| 40 | 58 | 45 | 1.8 | 55 | 3.9 | 2.2 | 4 | 0.02 | x |

As is clear from Table 2, in the case where scandia-stabilized zirconia (ScSZ) is employed, when the amount by volume of Ni and/or NiO is 35 to 55 vol. %, as reduced to Ni, on the basis of the entirety of the fuel-side electrode, and the amount by volume of ScSZ is 45 to 65 vol. % on the basis of the entirety of the fuel-side electrode, the change in size (ΔL) of the fuel-side electrode 110—which is determined from the sizes thereof measured before and after reduction treatment—can be controlled to fall within a range of ±0.05% by adjusting the ratio of the particle size of ScSZ to that of Ni and/or NiO (i.e., R2/R1), and adjusting the reducing agent content of the reducing gas employed for reduction treatment. As is also clear from Table 2, when the change in size (ΔL) of the fuel-side electrode 110 based on the sizes measured before and after the reduction treatment falls within a range of ±0.05%, problems (e.g., cracking in the electrolyte 120) do not occur.

Next will be described the case where gadolinium-doped ceria (GDC), which is a “solid solution of a cerium oxide with a rare earth element,” is employed as the ceramic material exhibiting oxygen ion conductivity and contained in the fuel-side electrode 110. A “solid solution of a cerium oxide with a rare earth element” may be represented by the following chemical formula: Ce₁₋ₓRₓO₃ (R: rare earth element, 0.05≦x≦0.20).

The same test as described above was carried out in the case where gadolinium-doped ceria was employed. Also in this case, the particle size ratio R2/R1 was adjusted to be 0.5 or more, and the reducing agent content of the reducing gas employed for reduction treatment is adjusted to fall within a range of 4 to 100 vol. %. The results are shown in Table 3. The “amount by volume of GDC” refers to the total amount by volume of GDC contained in the fuel-side electrode 110 on the basis of the volume of the entire fuel-side electrode 110 (exclusive of the volume of spaces taken by pores).

TABLE 3

| | | | Mean | | Mean | | Reducing | Change in size | |
|---|---|---|---|---|---|---|---|---|---|
| | Amount by | Amount by | particle size | Amount by | particle size | | gas | before and after | Occurrence |
| Combination | volume of | volume of | of NiO, Ni | volume of | of GDC | R2/R1 | amount | reduction | of |
| No. | NiO powder | Ni powder | R1 (μm) | GDC | R2 (μm) | ratio | (%) | ΔL/L1 (%) | cracking |
| 1 | 58 | 45 | 1.1 | 55 | 3.9 | 3.5 | 100 | 0.01 | x |
| 2 | 58 | 45 | 1.1 | 55 | 3.9 | 3.5 | 70 | 0.01 | x |
| 3 | 58 | 45 | 1.1 | 55 | 3.9 | 3.5 | 50 | 0.02 | x |
| 4 | 58 | 45 | 1.1 | 55 | 3.9 | 3.5 | 20 | 0.02 | x |
| 5 | 58 | 45 | 1.1 | 55 | 3.9 | 3.5 | 4 | 0.04 | x |
| 6 | 58 | 45 | 0.8 | 55 | 0.4 | 0.5 | 100 | 0.06 | ∘ |
| 7 | 58 | 45 | 0.8 | 55 | 0.4 | 0.5 | 70 | 0.06 | ∘ |
| 8 | 58 | 45 | 0.8 | 55 | 0.4 | 0.5 | 50 | 0.03 | x |
| 9 | 58 | 45 | 0.8 | 55 | 0.4 | 0.5 | 20 | 0 | x |
| 10 | 58 | 45 | 0.8 | 55 | 0.4 | 0.5 | 4 | 0 | x |
| 11 | 53 | 40 | 0.8 | 60 | 0.4 | 0.5 | 100 | 0 | x |
| 12 | 53 | 40 | 0.8 | 60 | 0.4 | 0.5 | 70 | 0 | x |
| 13 | 53 | 40 | 0.8 | 60 | 0.4 | 0.5 | 50 | −0.02 | x |
| 14 | 53 | 40 | 0.8 | 60 | 0.4 | 0.5 | 20 | −0.03 | x |
| 15 | 53 | 40 | 0.8 | 60 | 0.4 | 0.5 | 4 | −0.03 | x |
| 16 | 51 | 37.5 | 0.8 | 62.5 | 0.4 | 0.5 | 100 | 0 | x |
| 17 | 51 | 37.5 | 0.8 | 62.5 | 0.4 | 0.5 | 70 | −0.02 | x |
| 18 | 51 | 37.5 | 0.8 | 62.5 | 0.4 | 0.5 | 50 | −0.04 | x |
| 19 | 51 | 37.5 | 0.8 | 62.5 | 0.4 | 0.5 | 20 | −0.04 | x |
| 20 | 51 | 37.5 | 0.8 | 62.5 | 0.4 | 0.5 | 4 | −0.04 | x |
| 21 | 48 | 35 | 0.8 | 65 | 0.4 | 0.5 | 100 | 0.04 | x |
| 22 | 48 | 35 | 0.8 | 65 | 0.4 | 0.5 | 70 | 0.02 | x |
| 23 | 48 | 35 | 0.8 | 65 | 0.4 | 0.5 | 50 | 0.02 | x |
| 24 | 48 | 35 | 0.8 | 65 | 0.4 | 0.5 | 20 | 0 | x |
| 25 | 48 | 35 | 0.8 | 65 | 0.4 | 0.5 | 4 | −0.01 | x |
| 26 | 68 | 55 | 1.1 | 45 | 3.9 | 3.5 | 100 | −0.07 | ∘ |
| 27 | 68 | 55 | 1.1 | 45 | 3.9 | 3.5 | 70 | −0.06 | ∘ |
| 28 | 68 | 55 | 1.1 | 45 | 3.9 | 3.5 | 50 | −0.04 | x |
| 29 | 68 | 55 | 1.1 | 45 | 3.9 | 3.5 | 20 | −0.05 | x |
| 30 | 68 | 55 | 1.1 | 45 | 3.9 | 3.5 | 4 | −0.05 | x |
| 31 | 53 | 40 | 1.1 | 60 | 3.9 | 3.5 | 100 | 0.03 | x |
| 32 | 53 | 40 | 1.1 | 60 | 3.9 | 3.5 | 70 | 0 | x |
| 33 | 53 | 40 | 1.1 | 60 | 3.9 | 3.5 | 50 | −0.03 | x |
| 34 | 53 | 40 | 1.1 | 60 | 3.9 | 3.5 | 20 | −0.03 | x |
| 35 | 53 | 40 | 1.1 | 60 | 3.9 | 3.5 | 4 | −0.05 | x |
| 36 | 58 | 45 | 1.8 | 55 | 3.9 | 2.2 | 100 | −0.09 | ∘ |
| 37 | 58 | 45 | 1.8 | 55 | 3.9 | 2.2 | 70 | −0.07 | ∘ |
| 38 | 58 | 45 | 1.8 | 55 | 3.9 | 2.2 | 50 | −0.03 | x |
| 39 | 58 | 45 | 1.8 | 55 | 3.9 | 2.2 | 20 | 0 | x |
| 40 | 58 | 45 | 1.8 | 55 | 3.9 | 2.2 | 4 | 0.05 | x |

As is clear from Table 3, in the case where gadolinium-doped Celia (GDC) is employed, when the amount by volume of Ni and/or NiO is 35 to 55 vol. %, as reduced to Ni, on the basis of the entirety of the fuel-side electrode, and the amount by volume of GDC is 45 to 65 vol. % on the basis of the entirety of the fuel-side electrode, the change in size (ΔL) of the fuel-side electrode 110—which is determined from the sizes thereof measured before and after reduction treatment—can be controlled to fall within a range of ±0.05% by adjusting the ratio of the particle size of GDC to that of Ni and/or NiO (i.e., R2/R1), and adjusting the reducing agent content of the reducing gas employed for reduction treatment. As is also clear from Table 3, when the change in size (ΔL) of the fuel-side electrode 110 based on the sizes measured before and after the reduction treatment falls within a range of ±0.05%, problems (e.g., cracking in the electrolyte 120) do not occur.

1. A unit cell for a solid oxide fuel cell, the unit cell comprising a fuel-side electrode which also serves as a support, and which is formed of NiO, whose amount by volume is 35 to 55 vol. %, as reduced to Ni, on the basis of the entirety of the fuel-side electrode, and a ceramic material exhibiting oxygen ion conductivity, whose amount by volume is 45 to 65 vol. % on the basis of the entirety of the fuel-side electrode; a solid electrolyte; and an oxygen-side electrode, the solid electrolyte and the oxygen-side electrode being sequentially provided on a surface of the fuel-side electrode, wherein, when L2 represents the size of the fuel-side electrode as measured at ambient temperature, the fuel-side electrode being in the form of a reduced product obtained through thermal treatment in a reducing atmosphere at 800° C.; L1 represents the size of the fuel-side electrode as measured at ambient temperature, the fuel-side electrode being in the form of a non-reduced product before the thermal treatment; and a change in size (ΔL) of the fuel-side electrode is represented by (L2−L1), ΔL/L1 is −0.05 to 0.05%.

2. A unit cell for a solid oxide fuel cell according to claim 1, wherein, when R1 represents the mean particle size of NiO contained in the fuel-side electrode, and R2 represents the mean particle size of the ceramic material exhibiting oxygen ion conductivity contained in the fuel-side electrode, R2/R1 is 0.5 or more.

3. (canceled)

4. A unit cell for a solid oxide fuel cell according to claim 1, wherein the ceramic material exhibiting oxygen ion conductivity is Y₂O₃-stabilized ZrO₂.

5. A unit cell for a solid oxide fuel cell according to claim 1, wherein the ceramic material exhibiting oxygen ion conductivity is Sc₂O₃-stabilized ZrO₂.

6. A unit cell for a solid oxide fuel cell according to claim 1, wherein the ceramic material exhibiting oxygen ion conductivity is a solid solution of a cerium oxide with a rare earth element.

7. A unit cell for a solid oxide fuel cell according to claim 2, wherein the ceramic material exhibiting oxygen ion conductivity is Y₂O₃-stabilized ZrO₂.

8. A unit cell for a solid oxide fuel cell according to claim 2, wherein the ceramic material exhibiting oxygen ion conductivity is Sc₂O₃-stabilized ZrO₂.

9. A unit cell for a solid oxide fuel cell according to claim 2, wherein the ceramic material exhibiting oxygen ion conductivity is a solid solution of a cerium oxide with a rare earth element.

10. A solid oxide fuel cell comprising a unit cell for a solid oxide fuel cell as recited in claim 1.

11. A solid oxide fuel cell comprising a unit cell for a solid oxide fuel cell as recited in claim 2.

12. A solid oxide fuel cell comprising a unit cell for a solid oxide fuel cell as recited in claim 4.

13. A solid oxide fuel cell comprising a unit cell for a solid oxide fuel cell as recited in claim 5.

14. A solid oxide fuel cell comprising a unit cell for a solid oxide fuel cell as recited in claim 6.
